(19) United States
(12) Patent Application Publication
(10) Pub. No.: US 2003/0124031 A1
(43) Pub. Date: Jul. 3, 2003

(54) Process for regenerating a particulate filter and device for implementing the process

(75) Inventors: Frederic Dionnet, Berville en Roumois (FR); Olivier Trohel, Le-Petit-Quevilly (FR); Jean-Paul Morin, Auzebosc (FR)

Correspondence Address: IP DEPARTMENT OF PIPER RUDNICK LLP, 3400 TWO LOGAN SQUARE, 18TH AND ARCH STREETS, PHILADELPHIA, PA, 19103, US

(73) Assignee: CERTAM - Centre d'Etudes et de Recherche Technologique en Aerothermique et Moteur, Saint-Etienne-du-Rouvray (FR)

(21) Appl. No.: 10/310,382

(22) Filed: Dec. 5, 2002

Related U.S. Application Data
(63) Continuation of application No. PCT/FR01/01746, filed on Jun. 6, 2001.

(30) Foreign Application Priority Data
Jun. 6, 2000 (FR) FR00/07239

(51) Int. Cl. B01D 53/00

(52) U.S. Cl. 422/110; 422/178; 422/172

(57) ABSTRACT

A process for regenerating a particulate filter placed in an exhaust gas line of an internal combustion engine including burning particles emitted during combustion of fuel in the engine and retained in the filter in the presence of an additive containing at least one low-molecular-weight compound including at least two hydroxyl groups and wherein the hydroxyl groups are released in a cold state and an apparatus for regenerating a particulate filter placed in an exhaust gas line of an internal combustion engine, wherein regeneration includes burning particles retained in the filter and emitted during combustion of a fuel in the engine, in the presence of an additive, including a reservoir of an additive solution containing at least one low-molecular-weight compound including at least two hydroxyl groups which are released in a cold state, a meter enabling precise and variable metering of selected quantities of the additive solution injected, a start/stop controller, an electromagnetic injector controller, and pressure regulator driven by and automatically controlled by the engine.

### RELATED APPLICATION

This is a continuation of International Application No. PCT/FR01/01746, with an international filing date of Jun. 6, 2001, which is based on French Patent Application No. 00/07239, filed Jun. 6, 2000.

### FIELD OF THE INVENTION

This invention pertains to a process for regenerating particulate filters for an internal combustion engine.

### BACKGROUND

The internal combustion engines used in motor vehicles produce exhaust gases containing particles that have a detrimental effect on the environment. These particles are formed from residues of the fuel itself, as well as from the chemical additives added to the fuel, the combustion of which is not complete.

Elimination of these particles generated by internal combustion engines has become a major issue from the points of view of public health and the environment due to the increasing frequencies of respiratory diseases stemming from the degradation of the air quality.

For several years, solutions have been implemented as attempts to resolve the problem caused by these particulate emissions in the ambient air from internal combustion engines. For example, particulate filters have been inserted in the exhaust gas pipes downstream of internal combustion engines to retain these particles and prevent their release into the ambient air.

Nevertheless, these techniques have certain disadvantages due to the rapid fouling of the filter. As these filters are used, a miniscule part of the particles deposited on them is eliminated by combustion on the filter itself due to the high temperature of the exhaust gases which pass through it. However, most of the particles cannot be eliminated and as they accumulate, they finally block the filter and prevent evacuation of the combustion gases.

Processes for regenerating particulate filters have been envisaged. These processes augment the efficacy of the combustion of the particles on the filter essentially employing two different approaches.

According to the first approach, the combustion of the particles retained on the filter is improved by augmenting the temperature of said filter, e.g., by the use of heating elements around the filters, such as electric resistances or burners. This approach has numerous drawbacks. First, the supplementary supply of energy required for the combustion in the form of heat is costly. Second, the permanently employed high temperatures quickly result in degradation of the filters which thus exhibit a reduced lifespan.

A second approach consists of developing processes for diminishing the temperature at which the particles can be eliminated. This decrease in the combustion temperature of the particles on the filter has been obtained by adding different additives to the fuel, e.g., organometallic compounds.

These organometallic compounds have the role of a catalyst promoting the combustion of the particles deposited on the filter. However, their use can sometime result in sudden ignitions of the particles on the filter which is thereby subjected to noteworthy thermal shocks. Furthermore, these organometallic compounds themselves produce upon combustion supplementary deposits of metallic particles on the filter and present the major drawback of considerably increasing the cost of the process.

U.S. Pat. No. 5,055,112 discloses particular chemical compounds whose use as additives added to the fuel can reduce the levels of particles stemming from the combustion of diesel engines without the drawbacks associated with the use of organometallic derivatives. These additives comprise aliphatic 1,2-diol compounds having 6 to 24 carbon atoms. These compounds, constituted solely of carbon, hydrogen and oxygen, have the advantage of not producing additional residues upon their combustion.

However, these aliphatic 1,2-diol compounds whose aliphatic chain is longer than six carbon atoms have multiple disadvantages in addition to their carcinogenic potential. They must be handled with caution, their metering is not easy and lacks precision because of their physical state since they are practically solids at ambient temperature. Their use is, therefore, limited to miniscule proportions on the order of 500 to 5000 ppm, which thereby results in a limited reduction in the level of particles.

We have carried out research in the field of regenerating particulate filters and have now developed a process for regenerating filters with compositions comprising molecules which can be handled without risk, which can be easily metered and which have a moderate cost.

### SUMMARY OF THE INVENTION

This invention relates to a process for regenerating a particulate filter placed in an exhaust gas line of an internal combustion engine including burning particles emitted during combustion of fuel in the engine and retained in the filter in the presence of an additive containing at least one low-molecular-weight compound including at least two hydroxyl groups and wherein the hydroxyl groups are released in a cold state.

This invention also relates to a fuel for regenerating a particulate filter placed in an exhaust gas line of an internal combustion engine, including at least one low-molecular-weight compound including at least two hydroxyl groups.

This invention still further relates to an apparatus for regenerating a particulate filter placed in an exhaust gas line of an internal combustion engine, wherein regeneration includes burning particles retained in the filter and emitted during combustion of a fuel in the engine, in the presence of an additive, including a reservoir of an additive solution containing at least one low-molecular-weight compound including at least two hydroxyl groups which are released in a cold state, a meter enabling precise and variable metering of selected quantities of the additive solution injected, a start/stop controller, an electromagnetic injector controller, and pressure regulator driven by and automatically controlled by the engine.

### BRIEF DESCRIPTION OF THE DRAWINGS

FIG. 1 is a schematic installation diagram of a turbo diesel engine having direct electronic injection and utilizing a cordierite particulate filter in accordance with aspects of the invention.

FIG. 2 is a graph of loss of load as a function of time.

FIG. 3 is a graph of temperatures reached at the inlet of the filter as a function time.

### DETAILED DESCRIPTION

The invention includes a process for regenerating a particulate filter placed on the exhaust pipe for the gases emitted by an internal combustion engine, characterized in that the particles retained on the filter are burned in the presence of at last one low-molecular-weight compound comprising at least two hydroxyl groups.

The process of the invention is remarkable in that it enables almost complete elimination of almost the totality of the particles stemming from combustion to make available a clean filter. We have observed that these additives added in this manner have the effect of a noteworthy decrease in the combustion temperature of the particles on the filters.

We have also observed that in a surprising manner the low-molecular-weight compounds comprising at least two hydroxyl groups diminishing more effectively the combustion temperature of the particles on the filter are in the liquid state at ambient temperature. These compounds advantageously have a molecular weight lower than about 100.

Among the low-molecular-weight compounds comprising two hydroxyl groups, the invention envisages preferably organic compounds and advantageously glycerol and compositions containing glycerol.

The chemical compounds used in the process of the invention furthermore have the advantage of not producing ashes when they are decomposed under the effect of the heat and, thus, do not produce residues during their combustion.

Moreover, they are not carcinogenic and, since they are liquid at ambient temperature, they can be easily handled and metered. Finally, glycerol is produced industrially on a very large scale as a waste product stemming from the production of methyl ester from rapeseed.

We used these added compounds both directly in the exhaust gas pipe immediately upstream of the particulate filter or in the engine air intake upstream of the combustion chamber. The process of the invention, thus, can comprise at least the two following modes of implementation.

A first mode of implementation of the process of the invention comprises supplying substantially continuously or discontinuously a low-molecular-weight compound comprising at least two hydroxyl groups into the exhaust gas pipe upstream of the particulate filter. In this mode of implementation, addition of low-molecular-weight compounds comprising at least two hydroxyl groups is made in the form of a solution whose concentration of low-molecular-weight compounds comprising at least two hydroxyl groups is comprised between about 30 and about 100% by volume, especially preferably comprised between about 45 and about 55% by volume.

The concentration of low-molecular-weight compounds comprising at least two hydroxyl groups in the exhaust pipe upstream of the particulate filter is advantageously comprised between a volume of about 0.05 and about 0.5 l for a volume of 360,000 liters of exhaust gas, preferably comprised between about 0.1 and about 0.2 l for 360,000 liters of exhaust gas.

In this first mode of implementation, the solution containing the low-molecular-weight compounds comprising at least two hydroxyl groups is supplied at a flow rate comprised between about 0.1 and about 1 l/h, preferably of about 0.3 l/h.

A second mode of implementation of the process of the invention comprises supplying low-molecular-weight compounds comprising at least two hydroxyl groups upstream of the combustion chamber, advantageously in the fuel. In this mode of implementation, addition of low-molecular-weight compound comprising at least two hydroxyl groups is made in the form of a solution whose concentration in low-molecular-weight compounds comprising at least two hydroxyl groups is comprised between about 1 and about 4% of the volume of fuel, most preferably between about 1.5 and about 2% of the volume of fuel.

The invention also pertains to a fuel in which are present low-molecular-weight compounds comprising at least two hydroxyl groups advantageously at a concentration comprised between about 1 and about 4% by volume, most preferably between about 1.5 and about 2% by volume.

The invention also pertains to a device for the substantially continuous or discontinuous injection of low-molecular-weight-compounds comprising at least two hydroxyl groups and enabling precise and variable metering of the quantity injected as well as a start/stop control. The device comprises a control unit of a water-cooled electromagnetic injector. The device according to the invention also comprises pressure-regulation means driven and automatically controlled by the engine and enabling adjustment of the injection pressure of the additive in relation to engine operating conditions such as the evolution of the exhaust back pressure with the loading of the particulate filter.

The invention also pertains to an exhaust gas pipe equipped with an injection device as defined above.

Other advantages and characteristics of the invention will become clear from the examples below showing the effect of glycerol, one of the compounds used according to the invention, on the temperature measured at the inlet of the particulate filter and on the loss of load via the particulate filter.

1) Experimental Protocol

The experimental protocol was implemented on a turbo diesel engine with direct electronic injection, using a cordierite particulate filter.

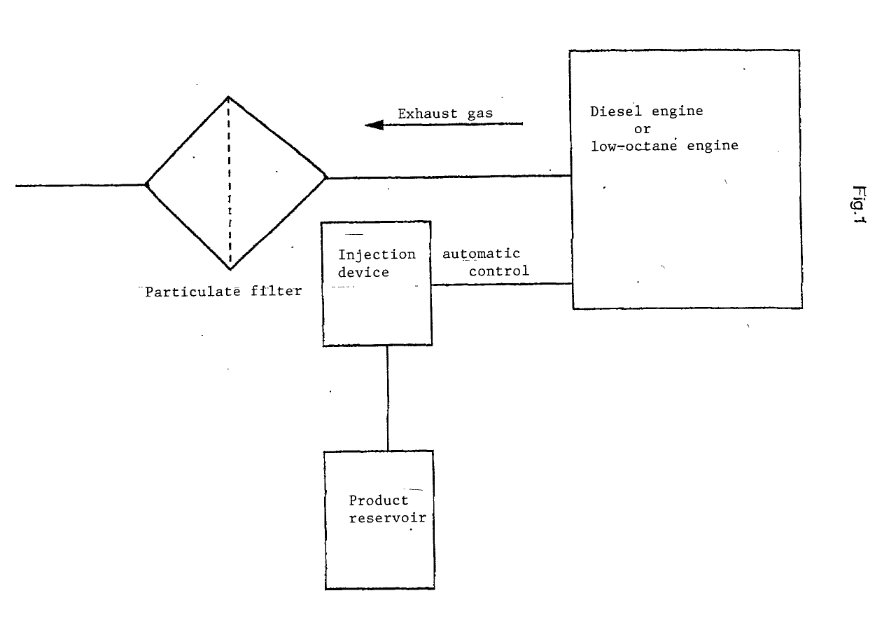

The solution used in the tests was formulated from pure glycerol at 90% to obtain a working solution containing 50% by volume of glycerol diluted in demineralized water. FIG. 1 represents an installation diagram of the above device.

2) Results

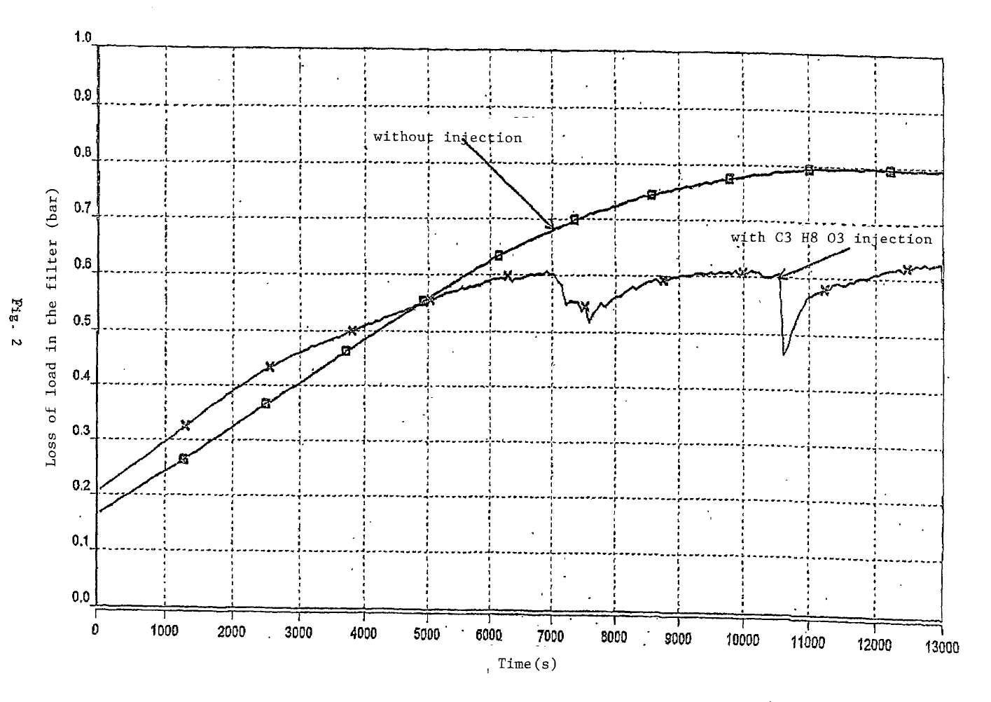

FIG. 2 is a comparison in terms of loss of load on the filter expressed in bar as a function of time for a filter not having been subjected to additive injection versus a filter that had been injected with glycerol at an additive flow rate through the filter of 300 ml/hour.

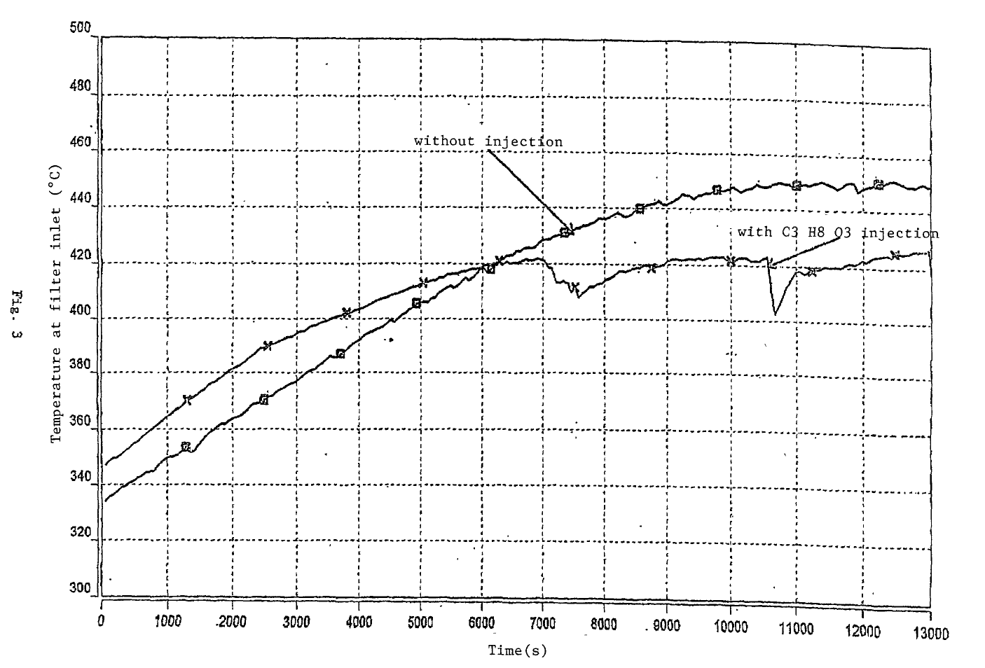

FIG. 3 illustrates the temperatures reached at the inlet of the filter in relation to the addition or not of the additives upstream of the filter. The maximum temperature after addition of glycerol was less than 400° C.

We observed during these studies on the regeneration of particulate filters the efficacy of certain small molecules comprising hydroxyl groups. While we do not wish to be bound by any particular theory, we believe that the mechanism of action of these molecules is probably linked to their chemical structure. The basic principle likely consists of a release of cold hydroxyl radicals leading to a reduction in the temperature required for the spontaneous combustion of the soot deposited on the filters. This cold release is produced starting at 300 or 400° C., whereas this same radical can only be produced in a conventional hydrocarbon flame above 1000° C., and such production would not be possible for molecules of the polyol type and carrying an OH group on each carbon atom. The temperature at which the phenomenon is produced depends in part on the oxygen partial pressure conditions existing in the exhaust pipes and in part on the soot formation rate. These two parameters are variables that depend on the engine operating conditions, notably on its state and its load.

1. A process for regenerating a particulate filter placed in an exhaust gas line of an internal combustion engine comprising burning particles emitted during combustion of fuel in the engine and retained in the filter in the presence of an additive containing at least one low-molecular-weight compound comprising at least two hydroxyl groups and wherein the hydroxyl groups are released in a cold state.

2. The process according to claim 1, wherein the hydroxyl groups are released at a temperature lower than about 400° C.

3. The process according to claim 1, wherein the low-molecular-weight compound is an organic molecule comprising a branched aliphatic chain possessing at least three carbon atoms.

4. The process according to claim 1, wherein the low-molecular-weight compound has a molecular weight lower than about 100.

5. The process according to claim 1, wherein the low-molecular-weight compound is glycerol.

6. The process according to claim 1, wherein the low-molecular-weight compound is added to the fuel before the fuel reaches a combustion chamber in the engine.

7. The process according to claim 1, wherein the low-molecular-weight compound is added into the exhaust gas line upstream of the particulate filter.

8. The process according to claim 1, wherein the low-molecular-weight compound is in solution form and the low-molecular-weight compound comprises between about 30 and about 100% by volume based on the volume of the solution.

9. The process according to claim 1, wherein the low-molecular-weight compound is in solution form and the low-molecular-weight compound comprises between about 45 and about 55% by volume based on the volume of the solution.

10. The process according to claim 1, wherein the low-molecular-weight compound is provided substantially continuously.

11. The process according to claim 1, wherein the low-molecular-weight compound is provided intermittently during periods of limited duration.

12. A fuel for regenerating a particulate filter placed in an exhaust gas line of an internal combustion engine, comprising at least one low-molecular-weight compound comprising at least two hydroxyl groups.

13. Apparatus for regenerating a particulate filter placed in an exhaust gas line of an internal combustion engine, wherein regeneration comprises burning particles retained in the filter and emitted during combustion of a fuel in the engine, in the presence of an additive, comprising:
a reservoir of an additive solution containing at least one low-molecular-weight compound comprising at least two hydroxyl groups which are released in a cold state;
a meter enabling precise and variable metering of selected quantities of the additive solution injected;
a start/stop controller;
an electromagnetic injector controller, and
a pressure regulator driven by and automatically controlled by the engine.

14. The device according to claim 13, wherein the pressure regulator adjusts injection of the additive in relation to evolution of an exhaust back pressure with loading of the particulate filter.

15. The device according to claim 12, wherein injection of the organic low-molecular-weight compound is performed substantially continuously.

16. The device according to claim 12, wherein injection of the organic low-molecular-weight compound is performed intermittently during periods of limited duration.
